(19) United States
(12) Patent Application Publication
(10) Pub. No.: US 2023/0408631 A1
(43) Pub. Date: Dec. 21, 2023

(54) RADAR INTERFERENCE MITIGATION

(71) Applicant: QUALCOMM Incorporated, San Diego, CA (US)

(72) Inventors: Yan LI, Beijing (CN); Shuping CHEN, Beijing (CN); Lu GAO, Beijing (CN); Ting WANG, Beijing (CN)

(21) Appl. No.: 18/247,020

(22) PCT Filed: Nov. 13, 2020
(86) PCT No.: PCT/CN2020/128638

§ 371 Date: Mar. 28, 2023

(51) Int. Cl. G01S 7/02; G01S 13/931

(52) U.S. Cl. CPC G01S 7/0232; G01S 2013/9316; G01S 13/931; G01S 7/0233

(57) ABSTRACT

In some aspects, a device may receive a communication indicating a first radar signal pattern parameter set associated with another device. The device may select, based at least in part receiving the communication indicating the first radar signal pattern parameter set, a second radar signal pattern parameter set that is different from the first radar signal pattern parameter set. The device may transmit a radar signal using the second radar signal pattern parameter set. Numerous other aspects are provided.

### FIELD OF THE DISCLOSURE

Aspects of the present disclosure generally relate to vehicle radar sensors and, for example, to radar interference mitigation.

### BACKGROUND

A vehicle may include a sensor system that includes one or more sensors to determine characteristics associated with the vehicle and/or characteristics associated with an environment of the vehicle. For example, such a sensor system may be configured to detect proximity to an object, a weather condition, a road condition, a vehicle speed, a traffic condition, a location of the vehicle, and/or the like.

### SUMMARY

In some aspects, a method of wireless communication performed by a device includes receiving a communication indicating a first radar signal pattern parameter set associated with another device; selecting, based at least in part receiving the communication indicating the first radar signal pattern parameter set, a second radar signal pattern parameter set that is different from the first radar signal pattern parameter set; and transmitting a radar signal using the second radar signal pattern parameter set.

In some aspects, a device for wireless communication includes a memory and one or more processors operatively coupled to the memory, the memory and the one or more processors configured to: receive a communication indicating a first radar signal pattern parameter set associated with another device; select, based at least in part receiving the communication indicating the first radar signal pattern parameter set, a second radar signal pattern parameter set that is different from the first radar signal pattern parameter set; and transmit a radar signal using the second radar signal pattern parameter set.

In some aspects, a non-transitory computer-readable medium storing a set of instructions for wireless communication includes one or more instructions that, when executed by one or more processors of a device, cause the device to: receive a communication indicating a first radar signal pattern parameter set associated with another device; select, based at least in part receiving the communication indicating the first radar signal pattern parameter set, a second radar signal pattern parameter set that is different from the first radar signal pattern parameter set; and transmit a radar signal using the second radar signal pattern parameter set.

In some aspects, an apparatus for wireless communication includes means for receiving a communication indicating a first radar signal pattern parameter set associated with another apparatus; means for selecting, based at least in part receiving the communication indicating the first radar signal pattern parameter set, a second radar signal pattern parameter set that is different from the first radar signal pattern parameter set; and means for transmitting a radar signal using the second radar signal pattern parameter set.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which radar interference mitigation described herein may be implemented, in accordance with various aspects of the present disclosure.

FIG. 2 is a diagram illustrating example components of one or more devices shown in FIG. 1, such as a vehicle on board unit or a roadside unit, in accordance with various aspects of the present disclosure.

FIGS. 3-5 are diagrams illustrating examples associated with radar interference mitigation, in accordance with various aspects of the present disclosure.

FIG. 6 is a flowchart of an example process associated with radar interference mitigation, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced, using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Many vehicles are equipped with advanced driver assistance systems (ADAS) designed to improve the convenience and safety of driving by warning the driver that a crash is imminent, temporarily automating and/or adapting vehicle control such as acceleration, braking, and steering, or otherwise aiding a motorist while driving. For example, ADAS technologies may support forward collision warnings, automatic emergency braking, lane departure warnings, lane keeping assistance, blind spot monitoring, rear cross-traffic alerts, adaptive cruise control, automated lighting, collision avoidance, and/or pedestrian crash avoidance mitigation. Furthermore, vehicles are increasingly equipped with technologies to support autonomous driving, whereby a vehicle moves safely with little or no human input. As ADAS, autonomous driving, and/or similar technologies become more prevalent, roadway crash rates may potentially be reduced by reducing incidents that occur (at least in part) due to human error (e.g., by alerting the driver to potential problems or controlling the vehicle to avoid collisions).

To enable ADAS features and/or autonomous driving, vehicles are generally equipped with a sensor suite including various sensors that can perceive or otherwise sense characteristics associated with the vehicle (e.g., movement data and/or location data) and/or characteristics associated with an environment surrounding the vehicle (e.g., signage, obstacles, the presence of other vehicles, and/or the presence of vulnerable road users such as pedestrians and/or bicyclists). For example, the sensor suite on a particular vehicle that supports ADAS features and/or autonomous driving may include one or more cameras, radar sensors, light detection and ranging (LIDAR) sensors, sonar sensors, global navigation satellite system (GNSS) receivers, vehicle odometers, and/or inertial measurement units.

A vehicle may use radar sensors to detect the location of targets, such as other vehicles, obstacles, or other objects, in the environment surrounding the vehicle. However, the performance of a vehicle's radar sensors may be degraded due to interference among from other radar signals (e.g., from other vehicles and/or roadside units, among other examples). For example, interfering radar signals can cause ghost targets to be detected by a radar sensor of a vehicle, resulting in false detection of targets in the environment of the vehicle. Furthermore, direct path interference with a radar signal transmitted by a radar sensor may jam the return path of the radar signal, thereby blocking detection of targets by the radar sensor. In some cases, a vehicle may attempt to avoid interference by performing standalone signal processing when transmitting or receiving radar signals. For example, the vehicle may select random radar signal parameters for transmitting the radar signal. However, radar sensors of the vehicle may still experience interference from other radar signals, leading to degradation of the performance of the radar signals, particularly when a quantity of vehicles attempting to simultaneously use active radar sensors in a given area exceeds a certain density (e.g., in urban environments and/or areas that frequently have dense traffic and/or congestion).

Some aspects described herein provide techniques and apparatuses to enable collaborative selection of radar signal transmission parameters based at least in part on in-band and/or out-of-band communications from other radar devices. Some aspects described herein enable a device to receive a communication indicating a radar signal pattern parameter set associated with another device. The device may select a radar signal pattern parameter set that is different from the radar signal pattern parameter set associated with the other device based at least in part on receiving the communication. The device transmits a radar signal using the selected radar signal pattern parameter set. In some aspects, the device may receive communications indicating respective radar signal parameter sets associated with multiple other devices, and the device may select the radar signal parameter set based at least in part on the radar signal parameter sets associated with the other devices. As a result, a device, such as a vehicle or a roadside unit, may eliminate or reduce interference due to radar signals from other devices, and therefore prevent or reduce degradation of radar sensor performance due to radar signal interference.

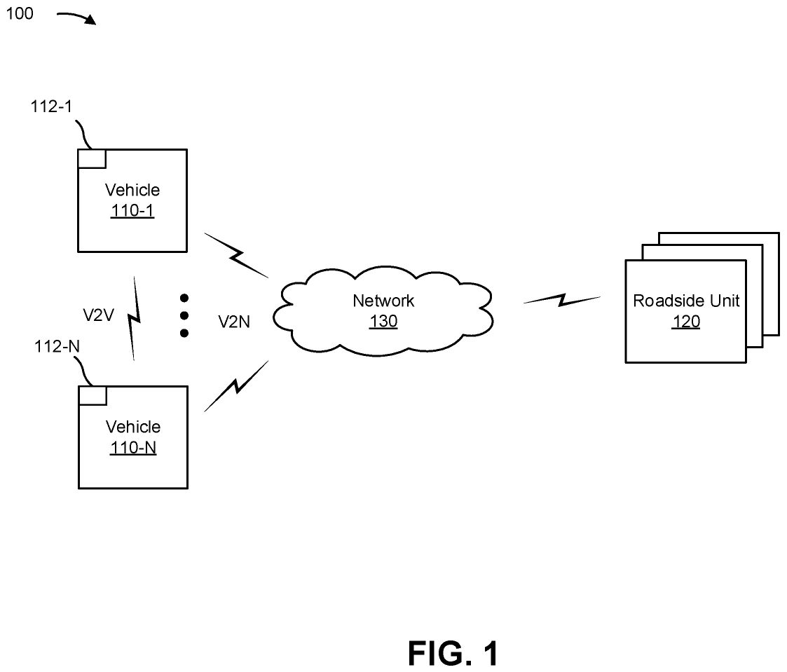

FIG. 1 is a diagram illustrating an example environment 100 in which radar interference mitigation described herein may be implemented, in accordance with various aspects of the present disclosure. As shown in FIG. 1, environment 100 may include one or more vehicles 110-1 to 110-N(referred to individually as a “vehicle 110” and collectively as “vehicles 110”) with corresponding onboard units (OBUs) 112-1 to 112-N(referred to individually as an “OBU 112” and collectively as “OBUs 112”), one or more roadside units (RSUs) 120 (referred to individually as an “RSU 120” and collectively as “RSUs 120”), and a network 130.

Devices of environment 100 may interconnect and/or communicate via wired connections, wireless connections, or a combination of wired and wireless connections. Furthermore, devices of environment 100 may communicate according to one or more vehicle-to-everything (V2X) protocols. For example, V2X communication is an umbrella term that generally refers to technologies that can be used to communicate information between a vehicle equipped with suitable communication capabilities and one or more other devices. For example, V2X communication may include vehicle-to-vehicle (V2V) communication technologies that allow vehicles to communicate with one another (e.g., to support safety systems with non-line-of-sight and latency-sensitive collision avoidance capabilities), vehicle-to-infrastructure (V2I) communication technologies that allow vehicles to communicate with infrastructure devices, such as street lights and/or buildings, among other examples, vehicle-to-pedestrian (V2P) communication technologies that allow vehicles to communicate with smartphones and/or connected wearable devices, among other examples, and/or vehicle-to-network (V2N) communication technologies that allow vehicles to communicate with network devices (e.g., according to a cellular V2X (C-V2X) protocol that uses Long Term Evolution (LTE) and/or New Radio (NR) as an enabling technology).

Vehicle 110 may include any vehicle that includes an onboard sensor suite, as described herein. For example, vehicle 110 may be a consumer vehicle, an industrial vehicle, or a commercial vehicle, among other examples. Vehicle 110 may be capable of traveling and/or providing transportation via public roadways or may be capable of use in operations associated with a worksite (e.g., a construction site), among other examples. Vehicle 110 may be controlled, at least in part, via OBU 112 and the onboard sensor suite. For example, in some aspects, vehicle 110 may use the onboard sensor suite to support one or more ADAS features (e.g., forward collision warnings, automatic emergency braking, lane departure warnings, lane keeping assistance, blind spot monitoring, and/or the like). Furthermore, in some aspects, vehicle 110 may use the onboard sensor suite to enable autonomous driving features.

OBU 112 may include one or more devices capable of receiving, generating, storing, processing, and/or providing information associated with radar interference mitigation, as described in further detail elsewhere herein. For example, in some aspects, OBU 112 may include a communication and/or computing device, such as an onboard computer, a control console, an operator station, or a similar type of device. In some aspects, OBU 112 may include one or more electrical control units (ECU) to control the onboard sensors and control the vehicle (e.g., steer, accelerate, and/or decelerate) based at least in part on information received from the onboard sensors. In some aspects, OBU 112 may include and/or be used in a radar interference mitigation system, as described herein. For example, OBU 112 may control vehicle 110 to receive communications including radar signal pattern parameter sets associated with other vehicles 110 and/or RSUs 120, select a radar signal pattern parameter set, broadcast a communication indicating the selected radar signal parameter set, and/or transmit a radar signal using the selected radar signal parameter set. In some aspects, although each vehicle 110 in FIG. 1 is shown to have one corresponding OBU 112, one or more vehicles 110 in environment 100 may include multiple OBUs 112.

RSU 120 may include one or more computing resources assigned to receive, generate, process, and/or provide information associated with radar interference mitigation, as described herein. RSU 120 includes a computing device deployed along a roadway and configured to wirelessly communicate with OBUs 112 of vehicles 110. In some aspects, some aspects, RSU 120 may include a cellular backhaul to enable communication with OBUs of vehicle 110 and/or other devices in network 130 (e.g., to support C-V2X communication). In some aspects, RSU 120 may include a rugged weatherproof housing suitable for outdoor installation in all weather conditions, and RSU 120 may include one or more interfaces to connect to power from an electrical grid (e.g., via an indirect connection, such as through a light pole or a traffic signal controller, or via a direct hardwire connection to the electrical grid).

In some aspects, RSU 120 may include a radar sensor, and RSU 120 may perform radar detection. For example, RSU 120 may perform radar detection of vehicles 110 in a vicinity of RSU 120. In some aspects, RSU 120 may broadcast a communication indicating a radar signal parameter set associated with RSU 120. In some aspects, RSU 120 may receive communications indicating radar signal parameter sets associated with vehicles 110 and select a radar signal parameter set associated with RSU 120 based at least in part on the received communications.

Network 130 includes one or more wired and/or wireless networks. For example, network 130 may include a cellular network (e.g., a fifth generation (5G) network, a fourth generation (4G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. Network 130 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

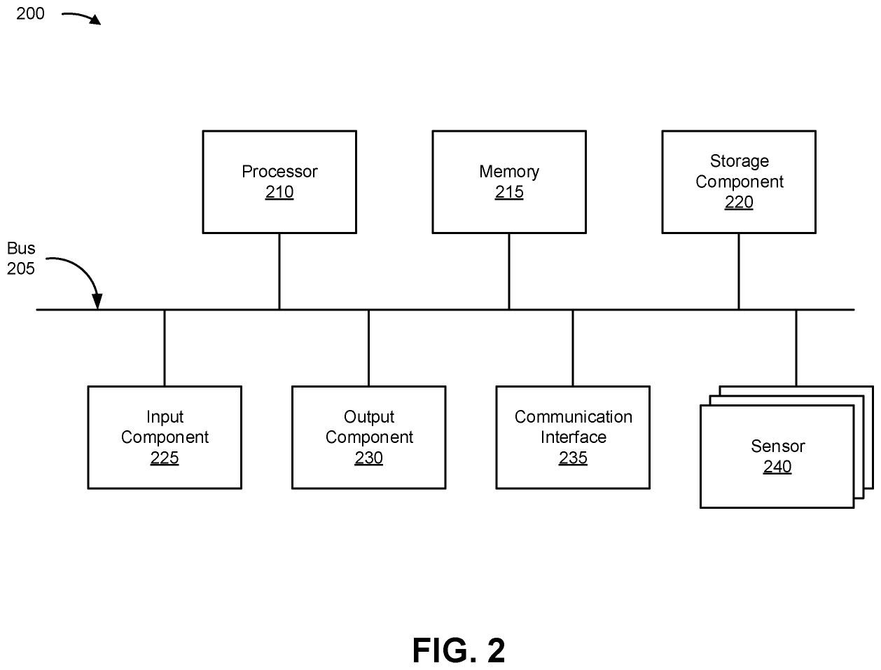

FIG. 2 is a diagram illustrating example components of a device 200, in accordance with various aspects of the present disclosure. Device 200 may correspond to vehicle 110, OBU 112, and/or RSU 120. In some aspects, vehicle 110, OBU 112, and/or RSU 120 may include one or more devices 200 and/or one or more components of device 200. As shown in FIG. 2, device 200 may include a bus 205, a processor 210, a memory 215, a storage component 220, an input component 225, an output component 230, a communication interface 235, and/or one or more sensors 240 (referred to individually as a “sensor 240” and collectively as “sensors 240”).

Bus 205 includes a component that permits communication among the components of device 200. Processor 210 is implemented in hardware, firmware, or a combination of hardware and software. Processor 210 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 includes one or more processors capable of being programmed to perform a function. Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component, a global navigation satellite system (GNSS) component, and/or the like) a sensor for sensing information (e.g., an accelerometer, a gyroscope, an actuator, another type of position or environment sensor, and/or the like)). Output component 230 includes a component that provides output information from device 200 (e.g., a display, a speaker, a haptic feedback component, an audio or visual indicator, and/or the like).

Communication interface 235 includes a transceiver-like component (e.g., a transceiver and/or a separate receiver and transmitter) that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency interface, a universal serial bus (USB) interface, a wireless local area interface (e.g., a Wi-Fi interface), a cellular network interface, and/or the like.

Sensor 240 includes one or more devices capable of sensing one or more characteristics of device 200 or an environment surrounding device 200. In some aspects, sensor 240 may include a radar sensor and one or more other sensor devices. For example, sensor 240 may include the radar sensor and one or more of a camera, a LIDAR sensor, a sonar sensor, an inertial measurement unit, and/or the like. Additionally, or alternatively, sensor 240 may include a magnetometer (e.g., a Hall effect sensor, an anisotropic magnetoresistive (AMR) sensor, or a giant magneto-resistive sensor (GMR)), a location sensor (e.g., a global positioning system (GPS) receiver and/or a local positioning system (LPS) device (e.g., that uses triangulation, multi-lateration), a gyroscope (e.g., a micro-electro-mechanical systems (MEMS) gyroscope or a similar type of device), an accelerometer, a speed sensor, a motion sensor, an infrared sensor, a temperature sensor, and/or a pressure sensor, among other examples.

Accordingly, sensor 240 may include any suitable sensor or combination of sensors that may be configured within a sensor suite to perform one or more operations, generate sensor data to permit one or more operations to be performed, and/or the like. For example, sensor 240 may be configured within a sensor suite to detect the presence of one or more objects in an environment of device 200, detect a proximity to one or more objects in the environment of device 200, determine a location of device 200, determine a speed associated with a device 200, determine a location and/or speed of one or more objects in the environment of device 200, and/or the like. In some aspects, sensor data generated by sensors 240 may be communicated (e.g., via communication interface 235) to another device to permit the sensor data to be used by the other device to perform one or more operations. Furthermore, in some aspects, the device 200 may select radar signal pattern parameters for radar signals transmitted by the radar sensor based at least in part on a communication indicating a radar signal pattern parameter set associated with another device.

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of the processes described herein. For example, device 200 may include means for receiving a communication indicating a first radar signal pattern parameter set associated with another device; means for selecting, based at least in part receiving the communication indicating the first radar signal pattern parameter set, a second radar signal pattern parameter set that is different from the first radar signal pattern parameter set; and/or means for transmitting a radar signal using the second radar signal pattern parameter set. In some aspects, such means may include one or more components of device 200 described in connection with FIG. 2, such as bus 205, processor 210, memory 215, storage component 220, input component 225, output component 230, communication interface 235, and/or sensor 240.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

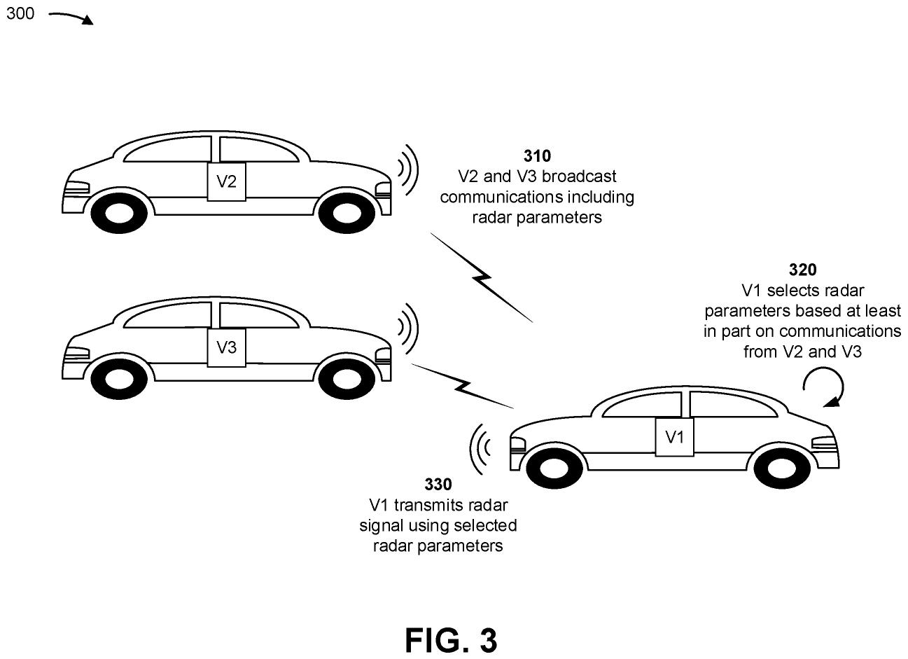

FIG. 3 is a diagram illustrating an example 300 associated with radar interference mitigation, in accordance with various aspects of the present disclosure. As shown in FIG. 3, example 300 includes communication between a first vehicle (shown as “V1”), a second vehicle (shown as “V2”), and a third vehicle (“shown as V3”). In some aspects, the first vehicle, the second vehicle, and the third vehicle may correspond to vehicles 110 shown in FIG. 1. Accordingly, the first vehicle, the second vehicle, and the third vehicle may each include an OBU (corresponding to OBU 112).

In some aspects, the vehicles may communicate with each other and/or one or more RSUs via V2X communications, such as C-V2X communications. For example, the vehicles may be enabled to communicate with each other using V2X communications when the vehicles are within a threshold distance that permits communication over a V2X interface or V2X channel. In some aspects, the vehicles may communicate with each other and/or one or more RSUs using in-band communications in a frequency band associated with radar sensors of the vehicles (e.g., using an ALOHA protocol or a Carrier-Sense Multiple Access (CSMA) protocol). As described herein, when referring to a vehicle performing an action (e.g., receiving information, broadcasting information, selecting radar signal pattern parameters, and/or transmitting a radar signal), it is to be understood that an OBU of the vehicle may be performing the action and/or controlling a radar sensor of the vehicle to perform the action.

As shown in FIG. 3, and by reference number 310, the second vehicle and the third vehicle may broadcast communications including radar signal pattern parameters. In some aspects, the second vehicle and the third vehicle may each select a respective radar signal pattern parameter set associated with that vehicle and broadcast a respective communication indicating the respective radar signal pattern parameter set associated with that vehicle. The radar signal pattern parameter set for a vehicle may be a set of parameters related to a radar signal pattern transmitted by a radar sensor of that vehicle.

In some aspects, the radar sensors of the vehicles may transmit frequency-modulated continuous wave radar (FMCW) radar signals. In this case, the radar signal may be transmitted with a sawtooth radar signal pattern, and the radar signal pattern parameter set may include parameters related to the sawtooth radar signal pattern. For example, the radar signal pattern parameter set may include one or more of a frequency, a bandwidth, a slope up duration, a slope down duration, and/or a slope off duration for the transmitted radar signal pattern. In some aspects, other radar waveforms may be used, such as phase-modulated continuous waveform (PMCW), and the radar signal parameter set may include parameters related to the type of radar waveform used. The radar signal pattern parameters may be referred to herein as “radar parameters,” and the radar signal pattern parameter set may be referred to herein as the “radar parameter set.”

The second vehicle and the third vehicle may each randomly select the respective radar parameter set associated with that vehicle. In some aspects, the vehicle (e.g., the second vehicle or the third vehicle) may randomly select each radar parameter (e.g., frequency, bandwidth, slope up duration, slope down duration, and/or slope off duration) within a respective range of values associated with each radar parameter. In some aspects, the vehicle may randomly select the radar parameter set from a plurality of radar parameter sets. In this case, each vehicle may store information identifying the plurality of radar parameter sets. For example, each vehicle may store a lookup table including information identifying, for each of the plurality of radar parameter sets, values of the radar parameters for the radar parameter set and an index associated with the radar parameter set. The vehicle may select the radar parameter set associated with that vehicle by randomly selecting an index value and selecting the radar parameter set associated with the index value. In some aspects, the second vehicle and/or the third vehicle may select the radar parameter set based at least in part a communication, received from another vehicle or RSU that indicates a radar parameter set associated with another vehicle or RSU, as described elsewhere herein in connection with the first vehicle.

The second vehicle and third vehicle may each broadcast a respective communication indicating the radar parameter set associated with that vehicle. In some aspects, the second vehicle and the third vehicle may each periodically broadcast the respective communication indicating the radar parameter set associated with that vehicle. For example, once a vehicle selects a radar parameter set and/or begins transmitting radar signals using the radar parameter set, the vehicle may periodically broadcast the communication indicating the radar parameter set at a certain time interval. Accordingly, as other vehicles come within a range of the communication (e.g., due to movement of the vehicles), the other vehicles may receive the broadcast communication and detect the radar parameters indicated in the communication.

In some aspects, the vehicle (e.g., the second vehicle or the third vehicle) may transmit an out-of-band communication including an indication of the radar parameter set. The out-of-band communication is a communication transmitted outside of a frequency band used by the vehicle for transmitting radar signals (e.g., 77 GHz frequency band). For example, the out-of-band communication may be a V2X communication, such as a 5.9 GHz V2X communication or V2X communication in another channel. In some aspects, the out-of-band communication may be a C-V2X PC5 communication transmitted from the vehicle to other devices (e.g. vehicles and/or RSUs) in a range of the vehicle via a PC5 interface. For example, the vehicle may transmit a newly defined message including the indication of the radar parameter set over the PC5 interface, or the vehicle may transmit an existing basic safety message with an added extension that indicates the radar parameter set over the PC5 interface. For example, the existing basic safety message may be a Basic Safety Message (BSM) defined in an SAE dedicated short range communications (DSRC) standard (e.g., SAE J2735) or a Cooperative Awareness Message (CAM) defined in an ETSI standard.

In some aspects, the vehicle (e.g., the second vehicle or the third vehicle) may transmit the indication of the radar parameter set in an in-band communication within a frequency band associated with transmitting the radar signals (e.g., 77 GHz frequency band). For example, the vehicle may transmit the in-band communication using a communication protocol (e.g., ALHOA protocol or CSMA protocol) capable of transmitting communications in the radar band. In some aspects, to avoid potential interference between the radar signal and the in-band communication, the spectrum used for transmitting the in-band communication may be a dedicated portion of the radar band (e.g., a dedicated sub-carrier within the radar band).

In some aspects, the indication of the radar parameter set included in the communication (e.g., the out-of-band or the in-band communication) may include parameter values for the radar parameters in the radar parameter set. For example, the indication may include parameter values for frequency, bandwidth, slope up duration, slope down duration, and/or slope off duration parameters associated with an FMCW radar waveform. In some aspects, the indication of the radar parameter set included in the communication (e.g., the out-of-band or the in-band communication) may include an index value associated with the parameter set. As described above, each radar parameter set of a plurality of radar parameter sets may be associated with a respective index value. In this case, the communication broadcast by the vehicle may indicate the radar parameter set associated with the vehicle using the index value associated with the radar parameter set. This may reduce signaling overhead and improve reliability, as compared with a communication that indicates the parameter values for the radar parameters in the radar parameter set.

The first vehicle may receive the communications broadcast by the second vehicle and third vehicle. For example, the first vehicle may receive a periodically broadcast communication indicating the radar parameter set associated with the second vehicle based at least in part on moving within a broadcast range of the second vehicle, and the first vehicle may receive a periodically broadcast communication indicating the radar parameter set associated with the third vehicle based at least in part on moving within a broadcast range of the third vehicle.

In some aspects, the first vehicle may select initial radar parameters prior to receiving the communications from the second vehicle and the third vehicle. For example, the first vehicle may select the initial radar parameters and transmit radar signals for radar detection prior to moving within a vicinity of the second vehicle or a vicinity of the third vehicle. In this case, the first vehicle may periodically transmit a communication (e.g., out-of-band communication or in-band communication) indicating the initial radar parameters associated with the first vehicle, as described above in connection with the second vehicle and the third vehicle.

As further illustrated in FIG. 3, and by reference number 320, the first vehicle may select radar parameters based at least in part on the communications received from second vehicle and third vehicle. The first vehicle may determine the radar parameter sets associated with the second vehicle and the third vehicle from the communications and select the radar parameters associated with the first vehicle based at least in part on the radar parameter sets associated with the second vehicle and the third vehicle. For example, the first vehicle may select a radar parameter set that is different from the radar parameter sets associated with the second vehicle and the third vehicle, in order to avoid interference from radar signals transmitted by the second vehicle and the third vehicle. For example, the selected radar parameter set for the first vehicle may include different values for one or more of the radar parameters, as compared with the radar parameter sets of the second vehicle and the third vehicle.

In some aspects, the first vehicle may randomly select a radar parameter set that is different from the parameter sets associated with the second vehicle and the third vehicle. For example, the first vehicle may randomly select values for the radar parameters in the radar parameter set that are different from the values in the radar parameter sets associated with the second vehicle and the third vehicle. As described above, a plurality of radar parameter sets may be associated with respective index values. In this case, the first vehicle may select the radar parameter set by randomly selecting an index value other than the index values indicating the respective parameter sets in the communications from the second vehicle and the third vehicle.

In some aspects, the first vehicle may utilize the radar parameters in the radar parameter sets associated with the second vehicle and the third vehicle to determine the values for the radar parameters associated with the first vehicle. In this case, the first vehicle may select parameter values that eliminate or reduce radar interference due to radar signals transmitted by the second vehicle and the third vehicle for radar detection performed using a radar signal associated with the selected parameters. For example, the first vehicle may perform an optimization algorithm to select parameter values predicted to eliminate interference due to the radar signals transmitted by the second vehicle and the third vehicle, or reduce the interference in cases in which the interference cannot be completely eliminated.

In some aspects, the first vehicle may select an initial radar parameter set prior to receiving the communications from the second vehicle and the third vehicle. In this case, the first vehicle may determine whether there is a conflict between the initial radar parameter set and at least one of the radar parameter set associated with the second vehicle or the radar parameter set associated with the third vehicle. For example, the first vehicle may determine there is a conflict in a case in which the radar parameter set associated with another vehicle (e.g., the second vehicle or the third vehicle) is the same as the initial radar parameter set associated with the first vehicle. The first vehicle may select a new radar parameter set that is different from the radar parameter set associated with the other vehicle based at least in part on determining that there is a conflict. The first vehicle may maintain the initial radar parameter set based at least in part on determining that there is not a conflict. In some aspects, as described in greater detail below, the first vehicle, may determine whether to select a new radar parameter set or maintain the initial radar parameter set when there is a conflict based at least in part on respective priority levels associated with the vehicles.

As further shown in FIG. 3, and by reference number 330, the first vehicle may transmit a radar signal using the selected radar parameter set associated with the first vehicle. The values of the radar parameters in the selected radar parameter set may define the radar signal pattern of the radar signal transmitted by the first vehicle. For example, the first vehicle may transmit an FMCW radar signal with a radar signal pattern determined based at least in part on values for frequency, bandwidth, slope up duration, slope down duration, and/or slope off duration parameters included in the selected radar parameter set. The first vehicle may transmit the radar signal to perform radar detection, for example to detect other vehicles and/or objects in an environment of the first vehicle.

In some aspects, the first vehicle may broadcast a communication indicating the selected radar parameter set associated with the first vehicle, based at least in part on selecting the radar parameter set. For example, the first vehicle may broadcast an out-of-band communication (e.g., V2X communication) indicating the selected radar parameter set or an in-band communication indicating the selected radar parameter set, as described above in connection with the second vehicle and the third vehicle. In some aspects, the first vehicle may periodically broadcast the communication at a certain time interval.

As described above in connection with FIG. 3, a first vehicle may receive communications indicating radar signal pattern parameter sets associated with other vehicles. The first vehicle may select a radar signal pattern parameter set that is different from the radar signal pattern parameter sets associated with the other vehicles based at least in part on receiving the communications. The first vehicle may transmit a radar signal using the selected radar signal pattern parameter set. As a result, the first vehicle may eliminate or reduce interference due to radar signals from other vehicles, and therefore prevent or reduce degradation of radar sensor performance due to radar signal interference.

As indicated above, FIG. 3 is provided as an example. Other examples may differ from what is described with respect to FIG. 3.

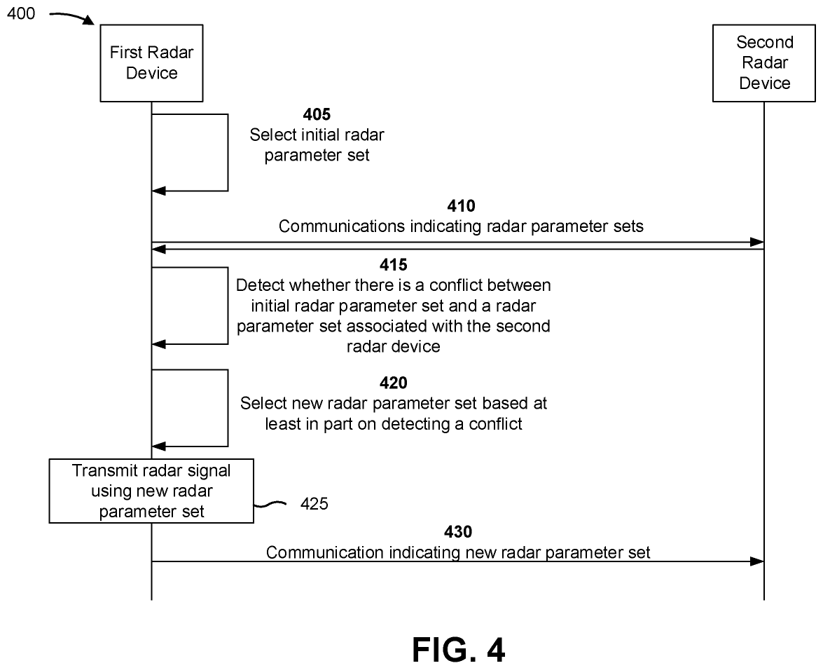

FIG. 4 is a diagram illustrating an example 400 associated with radar interference mitigation, in accordance with various aspects of the present disclosure. As shown in FIG. 4, example 400 includes communication between a first radar device and a second radar device. The first radar device may correspond to a vehicle (e.g., vehicle 110 of FIG. 1), an OBU (e.g., OBU 112 of FIG. 1), and/or an RSU (e.g., RSU 120 of FIG. 1). The second radar device may correspond to a vehicle (e.g., vehicle 110 of FIG. 1), an OBU (e.g., OBU 112 of FIG. 1), and/or an RSU (e.g., RSU 120 of FIG. 1).

In some aspects, the first radar device and the second radar device may communicate with each other via V2X communications, such as C-V2X communications. In some aspects, the first radar device and the second radar device may communicate with each other using in-band communications in a radar frequency band (e.g., using ALOHA protocol or Carrier-Sense Multiple Access (CSMA) protocol).

As shown in FIG. 4, and by reference number 405, the first radar device may select an initial radar parameter set. For example, the first radar device may randomly select the initial radar parameter set including one or more initial radar parameters (e.g., frequency, bandwidth, slope up duration, slope down duration, and/or slope off duration) related to a radar signal pattern of a radar signal to be transmitted by the first radar device. In some aspects, the first radar device may randomly select a value for each initial radar parameter within a respective range associated with that radar parameter. In some aspects, the first radar device may randomly select the initial radar parameter set from a plurality of radar parameter sets. For example, the first radar device may store information identifying, for each of the plurality of radar parameter sets, values of the radar parameters for the radar parameter set and an index associated with the radar parameter set. The first radar device may randomly select an index value and select the radar parameter set associated with the selected index value as the initial radar parameter set.

As further shown in FIG. 4, and by reference number 410, the first radar device may broadcast a communication indicating the initial radar parameter set associated with the first radar device, and the second radar device may broadcast a communication indicating a radar parameter set associated with the second radar device. The first radar device may receive the communication broadcast by the second radar device, and the second radar device may receive the communication broadcast by the first radar device. In some aspects, the first radar device and/or the second radar device may periodically broadcast the respective communications.

In some aspects, at least one of the first radar device or the second radar device may transmit an out-of-band communication including an indication of the radar parameter set associated with that device. For example, the out-of-band communication may be a V2X communication, such as a C-V2X PC5 communication transmitted via a PC5 interface. In some aspects, the radar device (e.g., the first radar device or the second radar device) may transmit a newly defined message associated indicating the radar parameter set over the PC5 interface. In some aspects, in a case in which the radar device transmitting the communication (e.g., the first radar device or the second radar device) is a vehicle (or an OBU), the radar device may transmit, via the PC5 interface, an existing basic safety message (e.g., a BSM or a CAM) with an added extension that indicates the radar parameter set. In some aspects, in a case in which the radar device transmitting the communication (e.g., the first radar device or the second radar device) is an RSU, the radar device may transmit, via the PC5 interface, an RSM with an added extension that indicates the radar parameter set.

In some aspects, at least one of the first radar device or the second radar device may transmit the indication of the radar parameter set in an in-band communication within the radar frequency band (e.g., 77 GHz frequency band). For example, the radar device (e.g., the first radar device or the second radar device) may transmit the in-band communication using a communication protocol (e.g., ALHOA protocol or CSMA protocol) capable of transmitting communications in the radar band. In some aspects, to avoid potential interference between the radar signal and the in-band communication, the spectrum used for transmitting the in-band communication may be a dedicated portion of the radar band (e.g., a dedicated sub-carrier within the radar band).

In some aspects, the indication of the radar parameter set included in the communication (e.g., the out-of-band or the in-band communication) may include parameter values for the radar parameters in the radar parameter set. In some aspects, the indication of the radar parameter set included in the communication (e.g., the out-of-band or the in-band communication) may include an index value associated with the parameter set.

As further shown in FIG. 4, and by reference number 415, the first radar device may detect whether there is a conflict between the initial radar parameter set and the radar parameter set associated with the second radar device. In some aspects, the first radar device may detect a conflict between the initial radar parameter set and the radar parameter set associated with the second radar device based at least in part on a determination that the initial radar parameter set is the same as the radar parameter set associated with the second radar device. In some aspects, the first radar device may predict interference for a radar signal transmitted using the initial radar parameter set based at least in part on the radar parameter set associated with the second radar device. In this case, the first radar device may detect a conflict between the initial radar parameter set and the radar parameter set associated with the second radar device based at least in part on a determination that the predicted interference is greater than a threshold.

As further shown in FIG. 4, and by reference number 420, the first radar device may select a new radar parameter set based at least in part of detecting a conflict between the initial radar parameter set and the radar parameter set associated with the second radar device. For example, the first radar device may select a new radar parameter set that is different from the radar parameter set associated with the second radar device, in order to avoid interference due to radar signals transmitted by the second radar device.

In some aspects, the first vehicle may randomly select the new radar parameter set that is different from the parameter set associated with the second radar device. For example, the first vehicle may randomly select values for the radar parameters in the new radar parameter set that are different from the values in the radar parameter set associated with the second radar device. As described above, a plurality of radar parameter sets may be associated with respective index values. In this case, the first radar device may select the new radar parameter set by randomly selecting an index value other than the index value corresponding to the radar parameter set associated with the second radar device.

In some aspects, the first radar device may utilize the radar parameters in the radar parameter set associated with the second radar device to determine the values for the radar parameters in the new radar parameter set associated with the first vehicle. In this case, the first radar device may select parameter values that eliminate or reduce radar interference, due to radar signals transmitted by the second radar device, on radar detection performed by the first radar device using a radar signal associated with the selected parameters. For example, the first radar device may perform an optimization algorithm to select parameter values predicted to eliminate or reduce interference due to the radar signals transmitted by the second radar device, based at least in part on the parameter values of the radar parameter set associated with the second radar device.

In some aspects, the first radar device may determine that there is no conflict between the initial radar parameter set and the radar parameter set associated with the second radar device. For example, the first radar device may determine that there is no conflict based at least in part on a determination that the initial radar parameter set is not the same as the radar parameter set associated with the second radar device. In this case, the first radar device may maintain the initial radar signal parameter set based at least in part on determining that there is no conflict. For example, in this case, the first radar device may transmit a radar signal to perform radar detection using the initial radar parameter set.

In some aspects, the first radar device may determine whether to select the new radar parameter set based at least in part on detecting a conflict between the initial radar parameter set and the radar parameter set associated with the second radar device and based at least in part on comparing a priority level associated with the first radar device and a priority level associated with the second radar device. In this case, different radar devices and/or different types of radar devices (e.g., vehicles or RSUs) may be associated with different priority levels. The communication, broadcast by a radar device (e.g., the first radar device and/or the second radar device), that indicates the radar parameter set associated with that radar device may also indicate the priority level associated with that radar device. In a case in which the first radar device detects a conflict between the initial radar parameter set and the radar parameter set associated with the second radar device, the first radar device may compare the priority level associated with the first radar device and the priority level associated with the second radar device. The first radar device may select a new radar parameter set based at least in part on a determination that the priority level associated with the second radar device is higher than or the same as the priority level associated with the first radar device. The first radar device may maintain the initial radar parameter set based at least in part on a determination that the priority level associated with the second radar device is lower than the priority level associated with the first radar device. In a case in which the priority level associated with the second radar device is lower than the priority level associated with the first radar device, the second radar device may select new radar parameter set.

As further shown in FIG. 4, and by reference number 425, the first radar device may transmit a radar signal using the new radar parameter set associated with the first radar device. The values of the radar parameters in the new radar parameter set may define the radar signal pattern of the radar signal transmitted by the first radar device. For example, the first radar device may transmit an FMCW radar signal with a radar signal pattern determined based at least in part on values for frequency, bandwidth, slope up duration, slope down duration, and/or slope off duration parameters included in the new radar parameter set. The first radar device may transmit the radar signal to perform radar detection, for example to detect vehicles and/or objects in environment of the first radar device.

As further shown in FIG. 4, and by reference number 430, the first radar device may broadcast a communication indicating the new radar parameter set. For example, the first radar device may broadcast an out-of-band communication (e.g., V2X communication) indicating the new radar parameter set or an in-band communication indicating the new radar parameter set, as described above. In some aspects, the first radar device may periodically broadcast the communication indicating the new radar parameter set at a certain time interval.

As described above in connection with FIG. 4, a first radar device, such as a vehicle, OBU, of RSU, may receive a communication indicating a radar signal pattern parameter set associated with a second radar device. The first radar device may detect whether there is a conflict between an initial radar signal pattern parameter set and the radar signal pattern parameter set associated with a second radar device. The first radar device may select a new radar signal pattern parameter set based at least in part on detecting a conflict between the initial radar signal pattern parameter set and the radar signal pattern parameter set associated with a second radar device. The radar device may transmit a radar signal using the new radar signal pattern parameter set, and broadcast a communication indicating the new radar signal pattern parameter set. As a result, a vehicle, OBU, or RSU may eliminate or reduce interference due to radar signals from other devices, and therefore prevent or reduce degradation of radar sensor performance due to radar signal interference.

As indicated above, FIG. 4 is provided as an example. Other examples may differ from what is described with respect to FIG. 4.

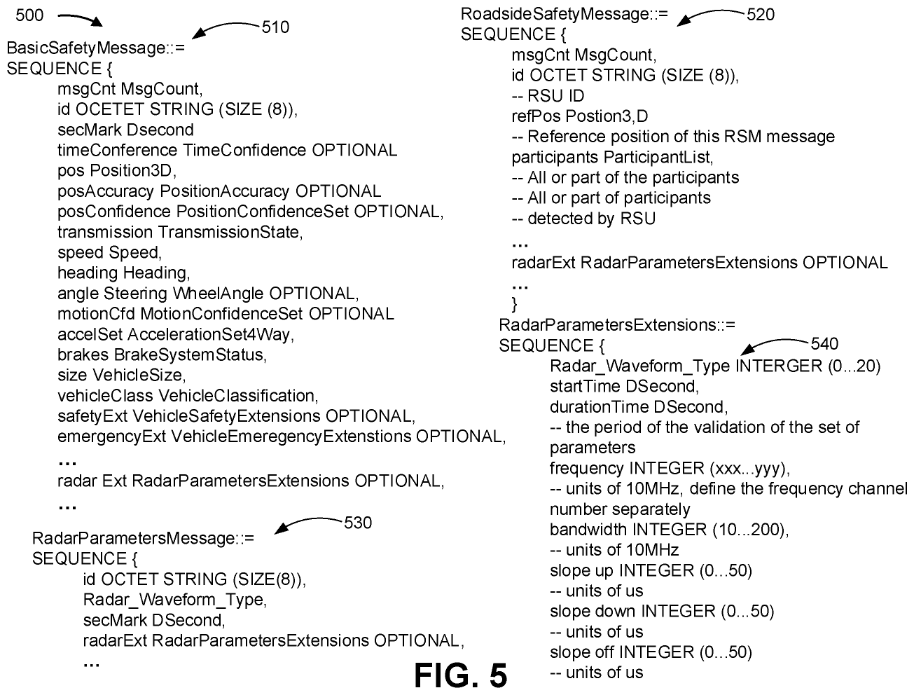

FIG. 5 is a diagram illustrating an example 500 associated with radar interference mitigation, in accordance with various aspects of the present disclosure. As shown in FIG. 5, example 500 includes example messages for broadcasting an indication of a radar parameter set associated with a device, such as a vehicle, OBU, or RSU.

As shown in FIG. 5, and by reference number 510, a BSM may be extended to include an extension (“RadarParametersExtensions”) that indicates radar parameters associated with a device. In some aspects, the BSM including the extension that indicates the radar parameters may be used by a vehicle/OBU to broadcast an out-of-band C-V2X communication indicating the radar parameter set associated with the vehicle/OBU.

As shown by reference number 520, an RSM may be extended to include the extension (“RadarParametersExtensions”) that indicates radar parameters associated with a device. In some aspects, the RSM including the extension that indicates the radar parameters may be used by an RSU to broadcast an out-of-band C-V2X communication indicating the radar parameter set associated with the RSU.

As shown by reference number 530, in some aspects, a C-V2X message (“ReadParametersMessage”) may be defined for broadcasting an indication of a radar parameter set associated with a device. The C-V2X message may include an indication of a radar waveform type for the radar parameter set and the extension (“RadarParametersExtensions”) that indicates radar parameters in the radar parameter set. In some aspects, the C-V2X message may be used by a vehicle/OBU or an RSU to broadcast an out-of-band C-V2X communication indicating the radar parameter set associated with the vehicle/OBU or the RSU.

As shown by reference number 540, the extension (“RadarParametersExtensions”) may include, for a waveform type, radar parameters associated with that waveform type. For example, as shown in FIG. 5, the extension may indicate values for a frequency parameter, a bandwidth parameter, a slope up duration parameter, a slope down duration parameter, and a slope off duration parameter.

As indicated above, FIG. 5 is provided as an example. Other examples may differ from what is described with respect to FIG. 5.

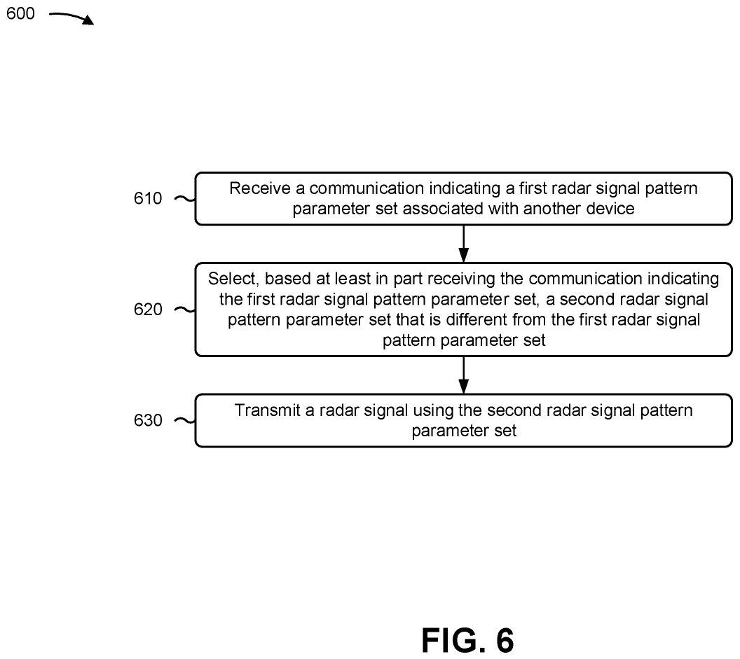

FIG. 6 is a diagram illustrating an example process 600 performed, for example, by a device, in accordance with various aspects of the present disclosure. Example process 600 is an example where the device (e.g., vehicle 110, OBU 112, or RSU 120) performs operations associated with radar interference mitigation.

As shown in FIG. 6, process 600 may include receiving a communication indicating a first radar signal pattern parameter set associated with another device (block 610). For example, the device (e.g., using processor 210, memory 215, storage component 220, input component 225, output component 230, communication interface 235, and/or sensor 240) may receive a communication indicating a first radar signal pattern parameter set associated with another device, as described above.

As further shown in FIG. 6, in some aspects, process 600 may include selecting, based at least in part receiving the communication indicating the first radar signal pattern parameter set, a second radar signal pattern parameter set that is different from the first radar signal pattern parameter set (block 620). For example, the device (e.g., using processor 210, memory 215, storage component 220, input component 225, output component 230, communication interface 235, and/or sensor 240) may select, based at least in part receiving the communication indicating the first radar signal pattern parameter set, a second radar signal pattern parameter set that is different from the first radar signal pattern parameter set, as described above.

As further shown in FIG. 6, in some aspects, process 600 may include transmitting a radar signal using the second radar signal pattern parameter set (block 630). For example, the device (e.g., using processor 210, memory 215, storage component 220, input component 225, output component 230, communication interface 235, and/or sensor 240) may transmit a radar signal using the second radar signal pattern parameter set, as described above.

Process 600 may include additional aspects, such as any single aspect or any combination of aspects described below and/or in connection with one or more other processes described elsewhere herein.

In a first aspect, the communication is a communication outside of a frequency band associated transmitting the radar signal.

In a second aspect, alone or in combination with the first aspect, the communication is a cellular vehicle to everything (C-V2X) PC5 communication.

In a third aspect, alone or in combination with one or more of the first and second aspects, the communication includes a basic safety message that includes an indication of the first radar signal parameter set or a cooperative awareness message that includes the indication of the first radar signal parameter set.

In a fourth aspect, alone or in combination with one or more of the first and second aspects, the communication includes a roadside safety message that includes an indication of the first radar signal pattern parameter set.

In a fifth aspect, the communication is a communication within a frequency band associated with transmitting the radar signal.

In a sixth aspect, alone or in combination with the fifth aspect, the communication is received in a dedicated portion of the frequency band associated with transmitting the radar signal.

In a seventh aspect, alone or in combination with one or more of the first through sixth aspects, the first radar signal pattern parameter set is one of a plurality of radar signal pattern parameter sets associated with corresponding indexes, and the communication includes an indication of the corresponding index associated with the first radar signal pattern parameter set.

In an eighth aspect, alone or in combination with one or more of the first through seventh aspects, selecting the second radar signal pattern parameter set that is different from the first radar signal pattern parameter set comprises randomly selecting a radar signal pattern parameter set that is different from the first radar signal pattern parameter set.

In a ninth aspect, alone or in combination with one or more of the first through eighth aspects, selecting the second radar signal pattern parameter set that is different from the first radar signal pattern parameter set comprises selecting an initial radar signal pattern parameter set, determining, based at least in part receiving the communication indicating the first radar signal pattern parameter set, that the first radar signal pattern parameter set is the same as the initial radar signal pattern parameter set, and selecting the second radar signal pattern parameter set that is different from the first radar signal pattern parameter set based at least in part on determining that the first radar signal pattern parameter set is the same as the initial radar signal pattern parameter set.

In a tenth aspect, alone or in combination with one or more of the first through ninth aspects, the communication includes a priority associated with the other device, and selecting the second radar signal pattern parameter set that is different from the first radar signal pattern parameter set based at least in part on determining that the first radar signal pattern parameter set is the same as the initial radar signal pattern parameter set comprises selecting the second radar signal pattern parameter set that is different from the first radar signal pattern parameter set based at least in part on determining that the first radar signal pattern parameter set is the same as the initial radar signal pattern parameter set and based at least in part on comparing a priority associated with the device and the priority associated with the other device.

In an eleventh aspect, alone or in combination with one or more of the first through tenth aspects, process 600 includes selecting an initial radar signal pattern parameter set, determining, based at least in part receiving the communication indicating the first radar signal pattern parameter set, that the first radar signal pattern parameter set is not the same as the initial radar signal pattern parameter set, and maintaining the initial radar signal pattern parameter set as the second radar signal pattern parameter set based at least in part on determining that the first radar signal pattern parameter set is not the same as the initial radar signal pattern parameter set.

In a twelfth aspect, alone or in combination with one or more of the first through eleventh aspects, process 600 includes broadcasting a communication indicating the second radar signal pattern parameter set.

In a thirteenth aspect, alone or in combination with the twelfth aspect, broadcasting the communication indicating the second radar signal pattern parameter set comprises periodically broadcasting the communication indicating the second radar signal pattern parameter set.

In a fourteenth aspect, alone or in combination with one or more of the twelfth and thirteenth aspects, broadcasting the communication indicating the second radar signal pattern parameter set comprises broadcasting the communication indicating the second radar signal pattern parameter set in at least one of a vehicle to everything (V2X) communication outside of a frequency band associated with transmitting the radar signal or a communication within the frequency band associated with transmitting the radar signal.

In a fifteenth aspect, alone or in combination with the first through fourteenth aspects, receiving a communication indicating a first radar signal pattern parameter set associated with another device comprises receiving a plurality of communications indicating radar signal pattern parameter sets associated with multiple other devices, and wherein selecting the second radar signal pattern parameter set comprises selecting the second radar signal pattern parameter set to reduce interference with the radar signal from radar signals transmitted by the multiple other devices based at least in part on the radar signal parameter sets associated with the multiple other devices.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a device, comprising:
receiving a communication indicating a first radar signal pattern parameter set associated with another device;
selecting, based at least in part receiving the communication indicating the first radar signal pattern parameter set, a second radar signal pattern parameter set that is different from the first radar signal pattern parameter set; and
transmitting a radar signal using the second radar signal pattern parameter set.

2. The method of claim 1, wherein the communication is a communication outside of a frequency band associated transmitting the radar signal.

3. The method of claim 1, wherein the communication is a cellular vehicle to everything (C-V2X) PC5 communication.

4. The method of claim 1, wherein the communication includes a basic safety message that includes an indication of the first radar signal parameter set or a cooperative awareness message that includes the indication of the first radar signal parameter set.

5. The method of claim 1, wherein the communication includes a roadside safety message that includes an indication of the first radar signal pattern parameter set.

6. The method of claim 1, wherein the communication is a communication within a frequency band associated with transmitting the radar signal.

7. The method of claim 6, wherein the communication is received in a dedicated portion of the frequency band associated with transmitting the radar signal.

8. The method of claim 1, wherein the first radar signal pattern parameter set is one of a plurality of radar signal pattern parameter sets associated with corresponding indexes, and the communication includes an indication of the corresponding index associated with the first radar signal pattern parameter set.

9. The method of claim 1, wherein selecting the second radar signal pattern parameter set that is different from the first radar signal pattern parameter set comprises:
randomly selecting a radar signal pattern parameter set that is different from the first radar signal pattern parameter set.

10. The method of claim 1, wherein selecting the second radar signal pattern parameter set that is different from the first radar signal pattern parameter set comprises:
selecting an initial radar signal pattern parameter set;
determining, based at least in part receiving the communication indicating the first radar signal pattern parameter set, that the first radar signal pattern parameter set is the same as the initial radar signal pattern parameter set; and
selecting the second radar signal pattern parameter set that is different from the first radar signal pattern parameter set based at least in part on determining that the first radar signal pattern parameter set is the same as the initial radar signal pattern parameter set.

11. The method of claim 10, wherein the communication includes a priority associated with the other device, and selecting the second radar signal pattern parameter set that is different from the first radar signal pattern parameter set based at least in part on determining that the first radar signal pattern parameter set is the same as the initial radar signal pattern parameter set comprises:
selecting the second radar signal pattern parameter set that is different from the first radar signal pattern parameter set based at least in part on determining that the first radar signal pattern parameter set is the same as the initial radar signal pattern parameter set and based at least in part on comparing a priority associated with the device and the priority associated with the other device.

12. The method of claim 1, selecting the second radar signal pattern parameter set that is different from the first radar signal pattern parameter set comprises:
selecting an initial radar signal pattern parameter set;
determining, based at least in part receiving the communication indicating the first radar signal pattern parameter set, that the first radar signal pattern parameter set is not the same as the initial radar signal pattern parameter set; and
maintaining the initial radar signal pattern parameter set as the second radar signal pattern parameter set based at least in part on determining that the first radar signal pattern parameter set is not the same as the initial radar signal pattern parameter set.

13. The method of claim 1, further comprising:
broadcasting a communication indicating the second radar signal pattern parameter set.

14. The method of claim 13, wherein broadcasting the communication indicating the second radar signal pattern parameter set comprises:
periodically broadcasting the communication indicating the second radar signal pattern parameter set.

15. The method of claim 13, wherein broadcasting the communication indicating the second radar signal pattern parameter set comprises:
broadcasting the communication indicating the second radar signal pattern parameter set in at least one of a vehicle to everything (V2X) communication outside of a frequency band associated with transmitting the radar signal or a communication within the frequency band associated with transmitting the radar signal.

16. The method of claim 1, wherein receiving a communication indicating a first radar signal pattern parameter set associated with another device comprises receiving a plurality of communications indicating radar signal pattern parameter sets associated with multiple other devices, and wherein selecting the second radar signal pattern parameter set comprises:
selecting the second radar signal pattern parameter set to reduce interference with the radar signal from radar signals transmitted by the multiple other devices based at least in part on the radar signal parameter sets associated with the multiple other devices.

17. A device for wireless communication, comprising:
a memory; and
one or more processors operatively coupled to the memory, the memory and the one or more processors configured to:
receive a communication indicating a first radar signal pattern parameter set associated with another device;
select, based at least in part receiving the communication indicating the first radar signal pattern parameter set, a second radar signal pattern parameter set that is different from the first radar signal pattern parameter set; and
transmit a radar signal using the second radar signal pattern parameter set.

18. The device of claim 17, wherein the communication is a communication outside of a frequency band associated transmitting the radar signal.

19. The device of claim 17, wherein the communication is a cellular vehicle to everything (C-V2X) PC5 communication.

20. The device of claim 17, wherein the communication comprises a basic safety message that includes an indication of the first radar signal parameter set, a cooperative awareness message that includes the indication of the first radar signal parameter set, or a roadside safety message that includes the indication of the first radar signal pattern parameter set.

21. The device of claim 17, wherein the communication is a communication within a frequency band associated with transmitting the radar signal.

22. The device of claim 17, wherein the first radar signal pattern parameter set is one of a plurality of radar signal pattern parameter sets associated with corresponding indexes, and the communication includes an indication of the corresponding index associated with the first radar signal pattern parameter set.

23. The device of claim 17, wherein the memory and the one or more processors configured to select the second radar signal pattern parameter set that is different from the first radar signal pattern parameter set are configured to:
randomly select a radar signal pattern parameter set that is different from the first radar signal pattern parameter set.

24. The device of claim 17, wherein the memory and the one or more processors configured to select the second radar signal pattern parameter set that is different from the first radar signal pattern parameter set are configured to:
select an initial radar signal pattern parameter set;
determine, based at least in part receiving the communication indicating the first radar signal pattern parameter set, that the first radar signal pattern parameter set is the same as the initial radar signal pattern parameter set; and
select the second radar signal pattern parameter set that is different from the first radar signal pattern parameter set based at least in part on determining that the first radar signal pattern parameter set is the same as the initial radar signal pattern parameter set.

25. The device of claim 24, wherein the communication includes a priority associated with the other device, and the memory and the one or more processors configured to select the second radar signal pattern parameter set that is different from the first radar signal pattern parameter set based at least in part on determining that the first radar signal pattern parameter set is the same as the initial radar signal pattern parameter set are configured to:
select the second radar signal pattern parameter set that is different from the first radar signal pattern parameter set based at least in part on determining that the first radar signal pattern parameter set is the same as the initial radar signal pattern parameter set and based at least in part on comparing a priority associated with the device and the priority associated with the other device.

26. The device of claim 17, wherein the memory and the one or more processors configured to select the second radar signal pattern parameter set that is different from the first radar signal pattern parameter set are configured to:
select an initial radar signal pattern parameter set;
determine, based at least in part receiving the communication indicating the first radar signal pattern parameter set, that the first radar signal pattern parameter set is not the same as the initial radar signal pattern parameter set; and
maintain the initial radar signal pattern parameter set as the second radar signal pattern parameter set based at least in part on determining that the first radar signal pattern parameter set is not the same as the initial radar signal pattern parameter set.

27. The device of claim 17, wherein the memory and the one or more processors are further configured to:
broadcast a communication indicating the second radar signal pattern parameter set.

28. The device of claim 27, wherein the memory and the one or more processors configured to broadcast the communication indicating the second radar signal pattern parameter set are configured to:
periodically broadcast the communication indicating the second radar signal pattern parameter set.

29. A non-transitory computer-readable medium storing a set of instructions for wireless communication, the set of instructions comprising:
one or more instructions that, when executed by one or more processors of a device, cause the device to:
receive a communication indicating a first radar signal pattern parameter set associated with another device;
select, based at least in part receiving the communication indicating the first radar signal pattern parameter set, a second radar signal pattern parameter set that is different from the first radar signal pattern parameter set; and
transmit a radar signal using the second radar signal pattern parameter set.

30. An apparatus for wireless communication, comprising:
means for receiving a communication indicating a first radar signal pattern parameter set associated with another apparatus;
means for selecting, based at least in part receiving the communication indicating the first radar signal pattern parameter set, a second radar signal pattern parameter set that is different from the first radar signal pattern parameter set; and
means for transmitting a radar signal using the second radar signal pattern parameter set.
